(19) United States
(12) Patent Application Publication
(10) Pub. No.: US 2009/0225720 A1
(43) Pub. Date: Sep. 10, 2009

(54) Base Station Cooperation and Channel Estimation

(76) Inventors: Andreas F. Molisch, Pasadena, CA (US); Zhifeng Tao, Allston, MA (US); Philip V. Orlik, Cambridge, MA (US); Jinyun Zhang, Cambridge, MA (US); Lun Dong, Irvine, CA (US); Lingjia Liu, Plano, TX (US); Toshiyuki Kuze, Kanagawa (JP)

Correspondence Address: MITSUBISHI ELECTRIC RESEARCH LABORATORIES, INC., 201 BROADWAY, 8TH FLOOR, CAMBRIDGE, MA, 02139, US

(21) Appl. No.: 12/358,619

(22) Filed: Jan. 23, 2009

Related U.S. Application Data
(60) Provisional application No. 61/035,235, filed on Mar. 10, 2008.

(51) Int. Cl. H04W 72/00; H04L 27/28

(52) U.S. Cl. 370/330; 370/329; 375/260

(57) ABSTRACT

A method estimates channels in a wireless cooperative cellular network including a set of base stations, and each base station communicates cooperatively with a set of mobile stations. A first sounding signal including a first midamble is transmitted from a first base station to a first mobile station. A second sounding signal including a second midamble is transmitted simultaneously from a second base station to the first mobile station, wherein the first and second midamble are disjoint in time, and wherein the first and second midambles are used to estimate the channels between the first base station and the first mobile station, and the second base station and the first mobile station, respectively.

### RELATED APPLICATION

This Non-Provisional Patent Application claims priority to Provisional Patent Application 61/035,235, “Base Station Cooperation and Channel Sounding,” filed by Molisch et al. on Mar. 10, 2008, incorporated herein by reference.

### BACKGROUND OF THE INVENTION

Performance at the edges of cells in mobile wireless networks, e.g., networks designed according to the IEEE 802.16e standard, is typically limited by interference. If full frequency reuse is employed, then the average SINR at the cell edge is around 0 dB. This is too low for useful communications with orthogonal frequency-division multiplexing (OFDM). To avoid the interference, fractional frequency reuse (FFR) is used in many networks. However, FFR schemes decrease sector throughput. For example, in the case of ⅓ FFR, the maximal throughput in this sector is limited to ⅓.

To improve the spectral efficiency, especially at the cell edge, new transmission schemes are needed. Base station (BS) cooperation avoids interference at specific locations. In particular, if the BSs cooperate by linear weighting of the transmit signal, then the preprocessing is transparent to the mobile stations (MSs). This enables full backward compatibility and low-cost implementation, while interference is greatly reduced. The BS cooperation can be characterized as “virtual multiple-input and multiple-output (MIMO) network,” where the antennas of all the cooperating BSs are the elements of the MIMO array that transmits to the MSs, thus taking advantage of additional spatial diversity and increasing network capacity, because each channel now carries additional information to multiple users.

### SUMMARY OF THE INVENTION

A method estimates channels in a wireless cooperative cellular network including a set of base stations, and each base station communicates cooperatively with a set of mobile stations.

A first sounding signal including a first midamble is transmitted from a first base station to a first mobile station.

A second sounding signal including a second midamble is transmitted simultaneously from a second base station to the first mobile station, wherein the first and second midamble are disjoint in time, and wherein the first and second midambles are used to estimate the channels between the first base station and the first mobile station, and the second base station and the first mobile station, respectively.

### BRIEF DESCRIPTION OF THE DRAWINGS

FIG. 1 is a schematic of a cooperative wireless network according to embodiments of the invention;

FIG. 2 is a schematic of cooperative communication according to embodiments of the invention;

FIGS. 3-5 are graphs comparing cooperation and non-cooperation in the network of FIG. 1; and

FIG. 6 is a block diagram of a sounding signal according to embodiments of the invention.

### DETAILED DESCRIPTION OF THE PREFERRED EMBODIMENTS

The embodiments of our invention provide for base station (BS) cooperation and channel estimation in a mobile wireless network. Channel estimation is also known as channel sounding or training. In this type of network, each BS communicates with a set of mobile stations (MSs) in the associated cell, i.e., the area around the BS. BS cooperation can reduce interference so that throughput is at least doubled or sometimes tripled.

BS cooperation can be implemented as a combination of macro-diversity handover (MDHO) mode and spatial division multiple access (SDMA) mode, both of which are part of the IEEE 802.16e standard. However, in the current standard, only one of the modes is used at any time.

By making minor modification to the training process, the BSs can determine correct coefficients for linear preceding.

Network Overview and Basic Implementation

We describe an IEEE 802.16m standard wireless network with a set of B base stations (BSs), each with Nₜ antennas, and K mobile Stations (MSs), each with Nᵣ receive antennas. In BS cooperation, multiple BSs can collaboratively transmit Lₖ data streams to the MSₖ.

Wireless Cellular Network

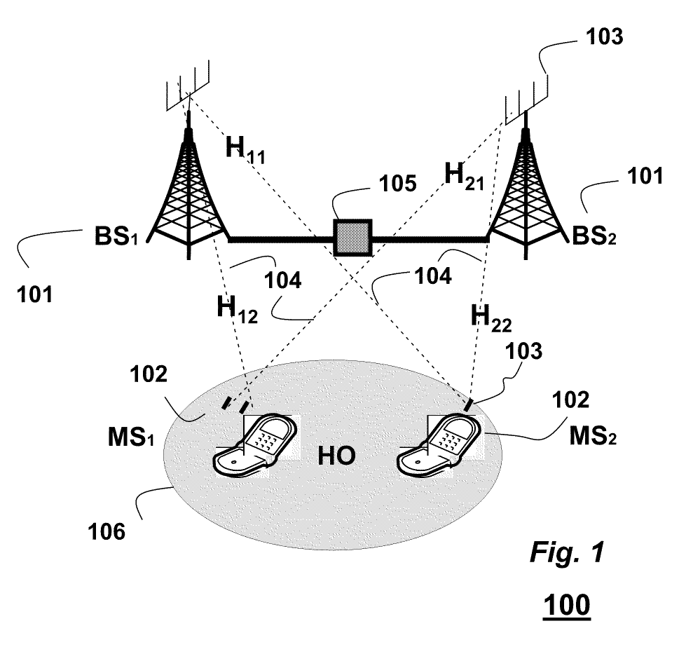

FIG. 1 shows a wireless cellular network 100 according to an embodiment of our invention. The network includes a set (two or more) of base stations (BSs) 101, and a set (two or more) of mobile stations (MSs) 102. Each station includes a transceiver. The transceivers are connected to a set of antennas 103. The dashed lines 104 indicate channels (links) between the transceivers. The corresponding channels matrices are B_{bk}.

A backbone or infrastructure 105 connects the BSs. Typically, the infrastructure includes wired and wireless connections, and processors that perform the high-level network functions as described herein. Base stations usually communicate with each other via the backbone 105 to exchange control information, channel information and even data traffic, which makes it possible for base stations to perform joint encoding and decoding.

The range of the signals from a base station defines a cell. Where signals from base stations overlap is known as a handover (HO) region 106.

In cooperation according to our invention, multiple (two or more) base stations coordinately communicate with multiple (two or more) MSs using the same resource, time and frequency. Cooperation can reduce ICI and improve spectral efficiency.

It is assumed that the transmission and particularly zone boundaries from neighboring base stations are synchronized as this is required for cooperation to work correctly.

We define H_{bk} (Nᵣ×Nₜ) as the baseband channel matrix between BS_{b} and MSₖ, the singular-value decomposition is conventionally defined as

H_{bk}=U_{bk}Λ_{bk}v_{bk}^{*},

where U and V are unitary matrices, Λ is diagonal matrix with nonnegative numbers on the diagonal, and V^{*} denotes the conjugate transpose of V.

The index of the serving BS of MSₖ is BSₖ. The transmit vector for MSₖ from BS_{b} is linearly precoded by the Nₜ×Lₖ matrix T_{bk} as x_{bk}=T_{bk}sₖ(m), where sₖ(m) denotes the zero-mean data vector, of size Lₖ×1 at time m, meant for MSₖ.

The matrix T_{bk}=0_{Nt×Lk}(b≠k) corresponds to the special case that each BS only serves the set of MSs in its own cell. That is, there is no BS cooperation.

In order to maximize the per-user transmission information rate, a Gaussian code book is used for the transmit data vectors, with normalized power, such that

E{sₖ(m)sₖ(m)^{*}}=I and E{sₖ(m)sₜ(m)^{*}}=0_{Lk×Lk}(for k≠1).

For the case of base station cooperation, the received signal at MSₖ is

$$\begin{matrix}{y}_{k} ( m ) = {\sum }_{b = 1}^{B} {H}_{bk} {x}_{bk} ( m ) + {\sum }_{{j = 1}_{j \neq k}}^{K} {\sum }_{b = 1}^{B} {H}_{bk} {x}_{bj} ( m ) + {n}_{k} ( m ) \\ = {\sum }_{b = 1}^{B} {H}_{bk} {T}_{bk} {s}_{k} ( m ) + {\sum }_{{j = 1}_{j \neq k}}^{K} {\sum }_{b = 1}^{B} {H}_{bk} {T}_{bk} {s}_{j} ( m ) + {n}_{k} ( m ) ,\end{matrix}$$

where nₖ(m) is an additive white Gaussian noise (AWGN) vector with covariance matrix NOI_{Nr}. The above equation can be also rewritten as

$${y}_{k} ( m ) = {H}_{k} {T}_{k} {s}_{k} ( m ) + {\sum }_{{j = 1}_{j \neq k}}^{K} {H}_{k} {T}_{j} {s}_{j} ( m ) + {n}_{k} ( m ) \\ where {H}_{k} = [ {H}_{1 k} , {H}_{2 k} , … , {H}_{Bk} ] and {T}_{k} = {[ {T}_{1 k}^{*} , {T}_{2 k}^{*} , … , {T}_{Bk}^{*} ]}^{*} \qquad ( 1 )$$

The goal of base station cooperation is to correctly design the transmitter precoding matrices {Tₖ, k-1,2, . . . K}. In this case, we maximize the sum rate capacity of the cooperative network. Essentially, if each BS has complete knowledge of all data and channel state information (CSI), e.g., the value of the channel matrix Hₖ, then significant capacity gains can be realized via precoding. As a result, the BSs need to exchange not only their CSI, but also their data streams, via the backbone 105 that has higher bandwidth. Different BSs can then collaboratively and simultaneously transmit data streams intended for different MSs.

The basic building blocks of a cooperative network already exist in the current IEEE 802.16e standard. In BS cooperation, the cooperating base and mobile stations can be grouped into a cooperation set, which is similar to the concept of a diversity set in macro-diversity handover (MDHO).

Data transmission during cooperation has significant resemblance to conventional MDHO, where multiple base stations communicate with one mobile station. Base station cooperation is also similar to conventional spatial division multiple access (SDMA), where one base station communicates with multiple mobile stations.

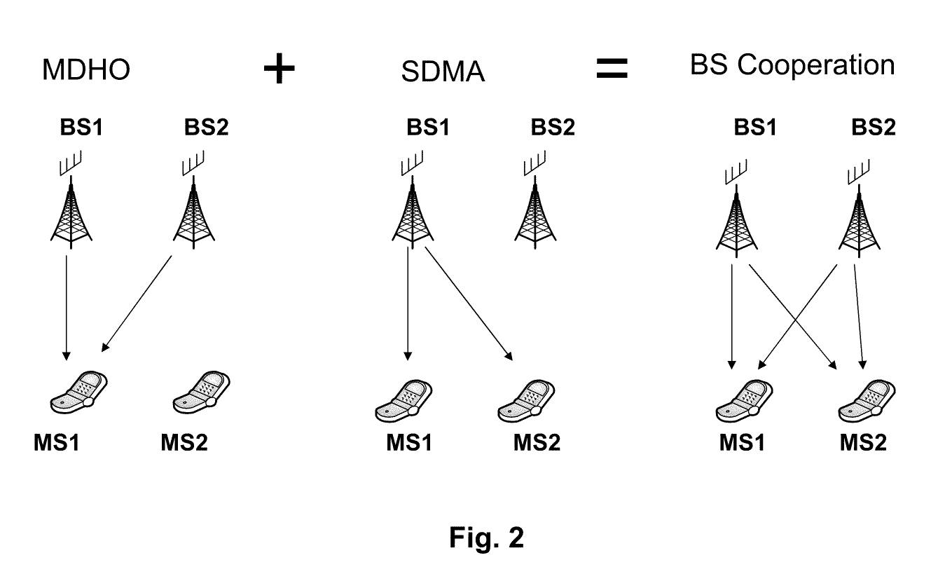

As shown in FIG. 2, we can view base station cooperation conceptually as a natural extension of MDHO and SDMA, i.e., MDHO+SDMA=BS cooperation. Thus enabling cooperation should require minimal modifications to the existing standard.

Simulation Results

We simulate the downlinks (DL) of the network of FIG. 1 that has two cells, each with one BS and one MS, such that the transmit and receive antennas are Nₜ−Nᵣ=2, data streams L−L=2, and equal transmission power for each BS. Although our interest is frequency selective channels, results for Rayleigh flat fading are also described for the completeness and comparison.

Rayleigh Flat Fading

We first describe Rayleigh flat fading channels. The inter-BS distance is 500 m. MSs are uniformly distributed in a limited cell area so that any MS is at least 150 m from its serving BS. The path-loss coefficient for all the BS-MS channels is 2.0 in free-space propagation, up to distance of 30 m, and increases to 3.7 thereafter.

Without loss of generality, the channel path-loss values are normalized with respect to the largest in-cell path-loss in the cell. Channel errors are modeled as zero-mean complex Gaussian random variables, with the same variance as the AWGN.

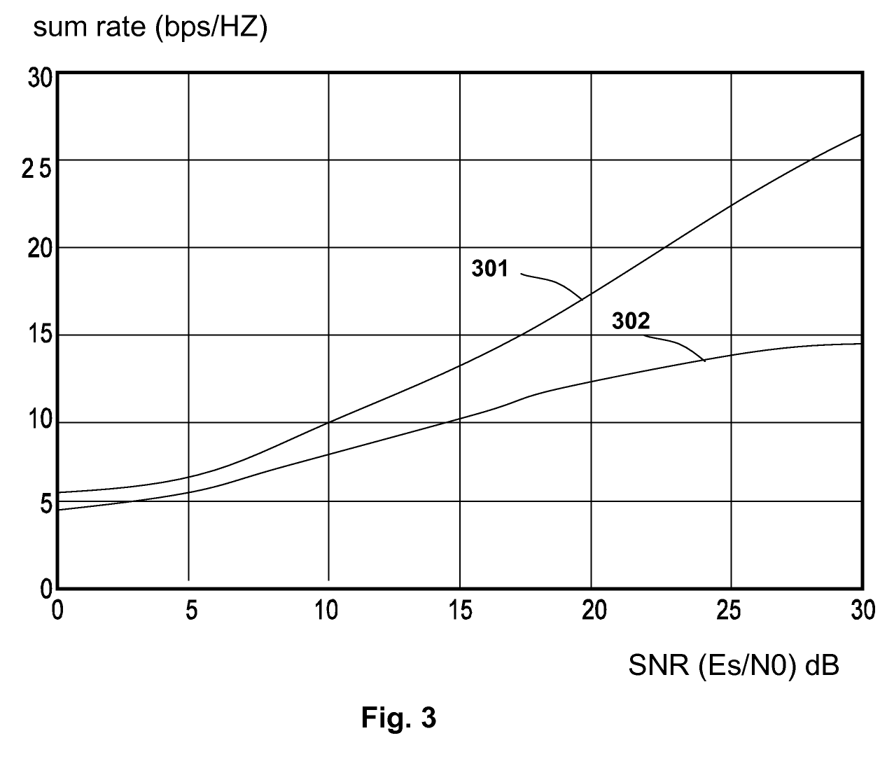

FIG. 3 compares the sum rate capacity (bps/HZ) as a function of the signal to noise ratio (SNR=Eₛ/N₀) dB of the network 100 for the case of cooperation 301 and non-cooperation 302.

In non-cooperative network, CSI exchange between the BSs is not available. Each BS only has knowledge of CSI of the MSs in its cell, i.e., Hₖₖ. The optimal precoding matrices to maximize the sum rate can be calculated based on the eigen-beamforming and equal power allocation on each data stream to each MS. In other words, the eigenvectors of the input covariance matrix (Tₖₖ)^{*}Tₖₖ are the first Lₖ columns of the matrix Vₖₖ, where Hₖₖ=UₖₖΛₖₖVₖₖ^{*}, every singular value of Tₖₖ equals P^{tx}/Lₖ. FIG. 3 shows that the gain from cooperation ranges from 2 dB at low SNR to over 10 dB at higher SNRs.

Frequency-Selective Fading

We also describe a simple but typical scenario for WiMax networks, where channels are frequency selective. The inter-BS distance is 1,500 m. MSs are uniformly distributed in a limited cell area so that any MS is at least 500 m from its serving BS. Other simulation parameters are summarized in Table I.

TABLE I
WiMAX simulation parameters

| | |
|---|---|
| FFT Size | 1024 |
| CP length | ⅛ |
| OFDM Symbol Duration | 102.86 us |
| Frame length | 5 ms |
| DL frame length | 30 OFDM Symbols |
| Carrier Frequency | 2.5 GHz |
| Bandwidth | 10 MHz |
| Sampling Frequency | 11.2 MHz |
| Subcarrier Allocation mode | AMC 1 × 6 |
| Channel Model | Urban Macro-cell |
| MS velocity | 5 m/s |

Without loss of generality, the channel path-loss values are normalized with respect to the largest in-cell path-loss in the cell. Channel errors on OFDM subcarriers are modeled as zero-mean complex Gaussian random variables, with same variance with AWGN.

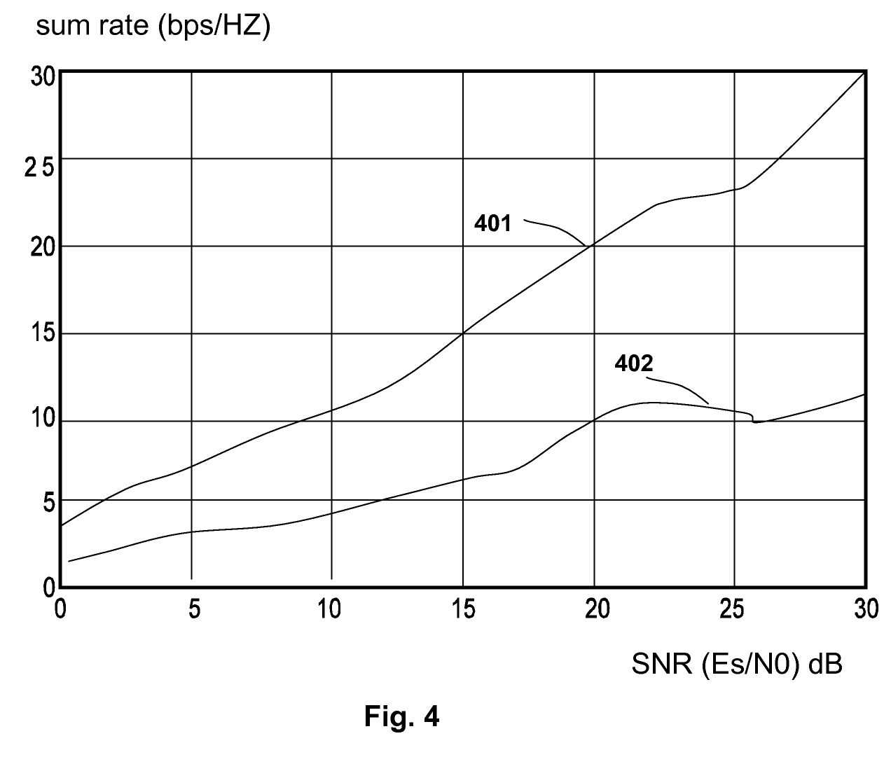

FIG. 4 compares the results for the cooperation 401 and non-cooperation 402. Again we see significant gains from the cooperation which indicates that base station cooperation can be highly effective in IEEE 802.16m standard networks.

Channel Estimation

To determine the preceding matrices, the transmitting BS must have knowledge of the channels as observed at the receiving MSs. We now describe the impact of imperfect channel knowledge on the achievable capacity of the cooperative network.

As described above, the preceding matrices are determined under perfect channel knowledge. However, under the condition that the distance from MS to the cooperating BSs are on the same order, which is typical for base station cooperation, the interference from the adjacent base station, while performing channel estimation, is non-negligible.

In conventional IEEE 802. 16e standard networks, channel estimation is performed during the transmission of preamble, midambles and/or during data transmission using pilot tones. The preamble and midambles can include one or more symbols.

Each channel sounding signal contains a pseudorandom number (PN) sequence, {c_{b,P}} unique to each base station. For a cooperative network to operate correctly, the transmissions from BSs need to occur simultaneously. Therefore, a certain amount of interference (self-interference) is expected during channel estimation. This interference is due to the non-orthogonality of the channel sounding signals among the base stations.

To analyze this interference, we again use the simple network with two BSs cooperating to deliver data streams to two MSs near the cell edge.

We define the following Network parameters:
N: number of subcarriers in the OFDM networks;
L: number of taps in the delay for frequency selective fading channels;
P: number of pilot symbols in a frame;
K: number of subcarriers between adjacent pilot symbols; and
hᵢ: column vector of dimension L×1 includes L channel taps for the channel from the base station to MSᵢ in the time-domain.

During the channel estimation, which can occur during the transmission of preambles, midambles, or data with pilots, the receiver estimates the channel for the received signal as

$$Y = {\sum }_{b = 1}^{2} [ \begin{matrix}{c}_{b , 0} & & \\ & ⋰ & \\ & & {c}_{b , P - 1}\end{matrix} ] {Fh}_{b} + n , \qquad ( 2 )$$

for coefficients c, where n is the P×1 complex noise vector on the pilot subcarriers, and F is a P×L discrete Fourier transform (DFT) matrix

$$F = [ \begin{matrix}{w}^{0} & {w}^{0} & {w}^{0} & ⋯ & {w}^{0} \\ {w}^{0} & {w}^{K} & {w}^{2 K} & ⋯ & {w}^{( L - 1 ) K} \\ ⋮ & ⋮ & ⋮ & ⋯ & ⋮ \\ {w}^{0} & {w}^{( P - 1 ) K} & {w}^{( P - 1 ) 2 K} & ⋯ & {w}^{( P - 1 ) ( L - 1 ) K}\end{matrix} ] , \\ with w = exp ( - j2π / N ) = exp ( - j2π / ( KP ) ) . \qquad ( 3 )$$

The receiver estimates the channels H_{b}, for b=1, 2, from the sounding signaling. The matrix H_{b}, is the frequency response of the channel which is the Fourier transform of h_{b}.

The MS performs a least-square (LS) estimate for both of the downlink channels. We focus on the estimate of the matrix H₁. The sufficient statistics for the estimate of H₁ are

$$\begin{matrix}{Y}_{1} = {Fh}_{1} + [ \begin{matrix}{c}_{1 , 0} {c}_{2 , 0} & & \\ & ⋰ & \\ & & {c}_{1 , P - 1} {c}_{2 , P - 1}\end{matrix} ] {Fh}_{2} + [ \begin{matrix}{c}_{1 , 0} & & \\ & ⋰ & \\ & & {c}_{1 , P - 1}\end{matrix} ] n \\ = {Fh}_{1} + [ \begin{matrix}{c}_{1 , 0} {c}_{2 , 0} & & \\ & ⋰ & \\ & & {c}_{1 , P - 1} {c}_{2 , P - 1}\end{matrix} ] {Fh}_{2} + {n}_{1} ,\end{matrix} \qquad ( 4 )$$

for coefficients c.

The noise vector n₁ has the same characteristics as the noise vector n. The LS estimate of h₁ is

$$\begin{matrix}{\hat{h}}_{1} = {( {F}^{*} F )}^{- 1} {F}^{*} {Y}_{1} \\ = {h}_{1} + {( {F}^{*} F )}^{- 1} {F}^{*} [ \begin{matrix}{c}_{1 , 0} {c}_{2 , 0} & & \\ & ⋰ & \\ & & {c}_{1 , P - 1} {c}_{2 , P - 1}\end{matrix} ] {Fh}_{2} + \\ {( {F}^{*} F )}^{- 1} {F}^{*} {n}_{1} ,\end{matrix} \qquad ( 5 )$$

The second term is the interference from BS2 when performing channel estimation for BS1. If the PN sequences are not orthogonal to each other and the fading is not frequency flat, then the interference level can be substantial.

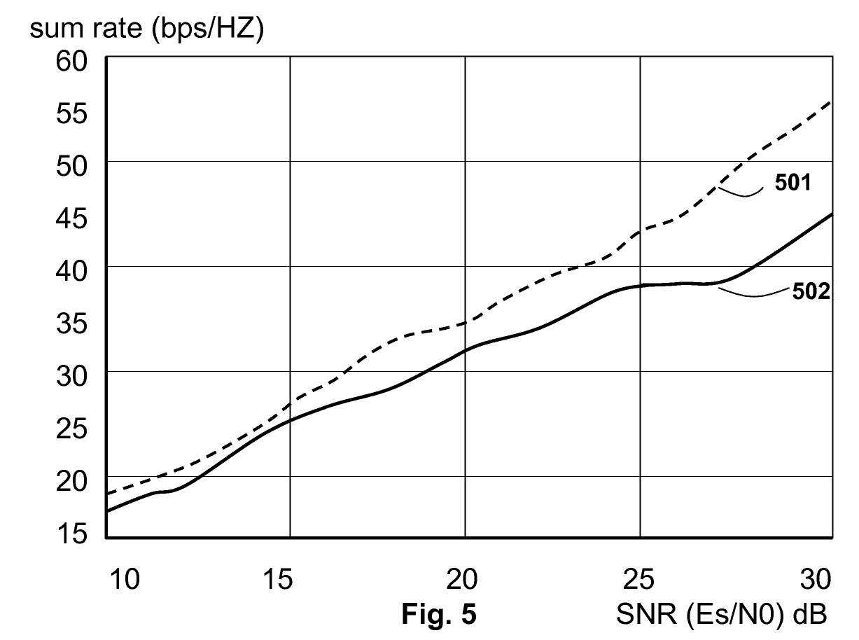

FIG. 5 compares the performance of two base station cooperation networks as follows. In the first network, the channel gains of the downlink channels are assumed to be perfectly known at the base station. The corresponding network throughput of the cooperation network as a function of SNR is labeled 501.

In the second network, we assume that the channel gains of the downlink channels are actually estimated using the least-square (LS) estimator. In this setting, both of the base stations, which participate in the cooperation transmit their midambles for the MIMO zone simultaneously through two transmit antennas. Each base station is equipped with a unique base station ID specified by IEEE 802.16e standard, and each transmit antenna of the same base station has a different midamble sequence. The transmitted power of the midambles from the two base stations are the same. The line 502 shows the actual network throughput of the base station cooperation network as a function of SNR.

The effects of the channel estimation errors on the network performance are clearly shown in FIG. 5. There are two interesting observations. First, there is a large gap in terms of sum rate between the perfect channel knowledge and channel estimation in the presence of interference. Second, as the SNR increases, unlike the noninterference network, the gap actually increases and the throughput of the base station cooperation under channel estimation errors quickly hits a floor. This is because at large SNRs the base station cooperation network is actually operating in the interference-limited regime.

These observations lead us to consider the required modification of the channel estimation in the IEEE 802.16m standard. The channel estimation should maintain orthogonality among the BSs that are cooperating to deliver data streams to multiple MSs.

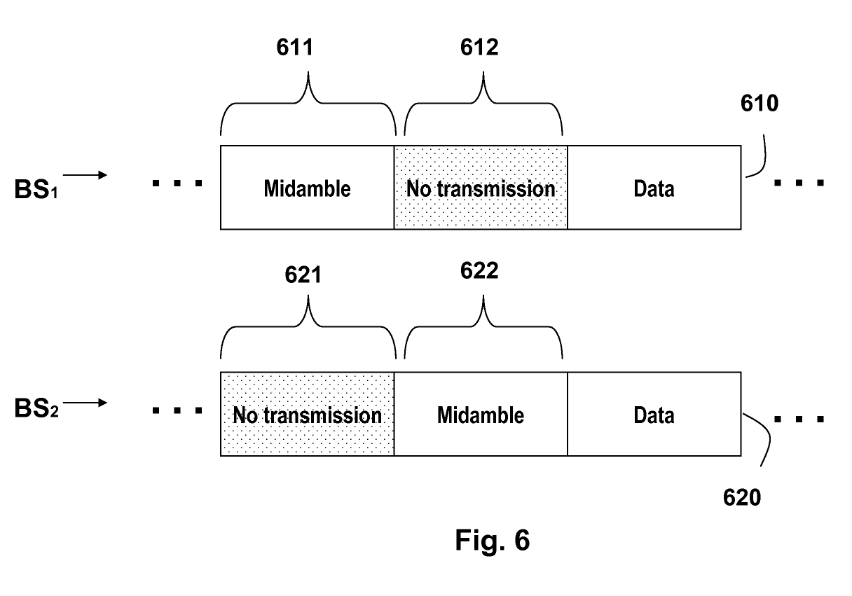

As shown in FIG. 6, this orthogonality can be achieved in time, by interleaving midamble symbols 611 and 612 for the sounding signals 610 and 620 transmitted by the a first station BS₁ and a second base station BS₂. The first and second sounding signals are transmitted simultaneously. However, the second base station does not transmit while the first base station transmits its midamble 611, and the first base station does not transmit while the second station transmit its midamble 622. That is, the midambles are transmitted disjoint in time. This way the receiver at the MS can estimate each channel without interference from the other BS.

Although this scheme has a small increase in overhead, the capacity gains from cooperation clearly out weigh the overhead. Our channel estimation interleaves the midambles so that they are not transmitted simultaneously from each BS.

To implement the scheme, the conventional frame structure is modified to increase the number of midamble symbols, so that the time interleaving shown in FIG. 6 can be accomplished.

Alternatively, the orthogonality can be maintained in the frequency domain by partitioning available subcarriers for the midamble symbols. Each cooperating base station can then use an orthogonal subset of subcarriers when transmitting its channel sounding signal.

Although the invention has been described with reference to certain preferred embodiments, it is to be understood that various other adaptations and modifications can be made within the spirit and scope of the invention. Therefore, it is the object of the append claims to cover all such variations and modifications as come within the true spirit and scope of the invention.

We claim:

1. A method for estimation channels in a wireless cooperative cellular network including a set of base stations and each base station within the set communicates cooperatively with a set of mobile stations, comprising:
transmitting, from a first base station to a first mobile station a first sounding signal including a first midamble;
transmitting simultaneously, from a second base station to the first mobile station, a second sounding signal including a second midamble, wherein the first and second midamble are orthogonal signals, and wherein the first and second midambles are used to estimate the channels between the first base station and the first mobile station and the second base station and the first mobile station, respectively.

2. The method of claim 1, wherein the sounding from the first base station and the second base station are disjoint in time.

3. The method of claim 1, wherein the sounding from the first base station and second base station are disjoint in frequency

4. The method of claim 1, wherein the set of base stations coordinately communicate with the sets of mobile stations.

5. The method of claim 1, further comprising:
synchronizing the transmitting.

6. The method of claim 5, wherein the set of base stations use the same time and frequency resource.

7. The method of claim 1, further comprising:
estimating the channels at the first mobile station; and
transmitting an estimation of the channels to the first base stations and the second base station.

8. The method of claim 1, further comprising:
maintaining an orthogonality in a frequency domain by partitioning available subcarriers for the midamble symbols.
The method of claim 1, further comprising:
transmitting simultaneously, from the first base station to a second mobile station the first sounding signal including the first midamble;
transmitting simultaneously, from the second base station to the first mobile station, the second sounding signal including the second midamble.

9. The method of claim 1, wherein the second base station does not transmit while the first base station transmits the first midamble, and the first base station does not transmit while the second station transmits the second midamble.
